(19) United States
(12) Patent Application Publication
(10) Pub. No.: US 2026/0264813 A1
(43) Pub. Date: Sep. 10, 2026

(54) CASTING PLATFORM SYSTEM AND MODULAR STABILITY ACCESSORIES THEREFOR

(71) Applicant: Joseph H. Nook, III, Pepper Pike, OH (US)

(72) Inventor: Joseph H. Nook, III, Pepper Pike, OH (US)

(21) Appl. No.: 19/661,818

(22) Filed: Apr. 29, 2026

Related U.S. Application Data
(63) Continuation-in-part of application No. 19/181,617, filed on Apr. 17, 2025.
(63) Continuation-in-part of application No. 17/972,316, filed on Oct. 24, 2022, now Pat. No. 12,637,176.
(60) Provisional application No. 63/271,384, filed on Oct. 25, 2021.

(51) Int. Cl. B63B 29/04; A01K 97/22

(52) U.S. Cl. CPC B63B 29/04; A01K 97/22; B63B 2029/046

(57) ABSTRACT

A casting platform system for mounting on a boat deck is disclosed. The casting platform system includes a platform and a modular stability accessory. The platform includes a base plate, a leg, and an attachment mechanism. The attachment mechanism is attached to a lower face of the base plate. The modular stability accessory includes a lateral member and a vertical member. The lateral member is configured to be removably coupled to the attachment mechanism of the platform. The vertical member extends upwardly away from the lateral member above the platform. The modular stability accessory can be a seat, sissy bar, cage, or other device.

### CROSS-REFERENCE TO RELATED APPLICATIONS

This application is a continuation-in-part of U.S. patent application Ser. No. 19/181,617, filed Apr. 17, 2025, and U.S. patent application Ser. No. 17/972,316, filed Oct. 24, 2022, which claims the benefit of U.S. Provisional Patent Application No. 63/271,384, filed Oct. 25, 2021, the entire contents of which are incorporated by reference herein.

### FIELD

This disclosure relates to fishing boats and equipment for improving the fishing experience for fishermen thereon, including casting platform systems for fishing boats or boat docks and modular stability accessories for improving the experience of fishermen.

### BACKGROUND

The information included in this Background section of the specification, including any references cited herein and any description or discussion thereof, is included for technical reference purposes only and is not to be regarded as subject matter by which the scope of the current disclosure is defined or the claims are to be bound.

Fly fishing presents unique challenges compared with other casting techniques for fishing. To cast, a fly angler performs an action (such as a back cast or roll) to load the rod with unspooled line, which (with the angler's forward rotation of the rod) propels the fly line forward. Fly fishing often involves quick presentation of a fly to a fish or area of water likely to hold fish based on the conditions observed by the angler (e.g., fish “rising” or “tailing” to feed, disturbance on the surface of the water, fleeting opportunity to cast to a spot while in motion, break in the wind, and so forth). To ensure that the angler can make these quick presentations, it is desirable for the angler to be elevated above the deck of the fishing boat to improve visibility, and for the angler to be capable of viewing and/or casting at different distances and in different directions based on changing conditions and opportunities to place a fly near a feeding fish.

An elevated casting platform provides a stable surface from which the fisherman can more easily identify and target fish to catch. The elevated casting platform can include support accessories that are typically integrally formed as part of the casting platform and are unable to be removed or altered after installation. In some situations, this may be undesirable and not provide the angler with sufficient flexibility for viewing and/or casting.

Casting from a position that is elevated above the deck of the fishing boat provides improved visibility of nearby fish. An elevated casting platform provides a stable surface from which the fisherman can more easily identify and target fish to catch. The elevated casting platform can include a straight leaning rail for the fisherman to lean against, a wrap-around leaning rail, a cage that provides 360-degree support for the fisherman, or a seat. These sitting or leaning options are typically formed as part of the casting platform and are unable to be removed or altered after installation.

Given the foregoing, it would be beneficial to develop improved casting platform systems and modular stability accessories therefor.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages, as defined in the claims, is provided in the following written description of various embodiments and illustrated in the accompanying drawings.

In an example, a casting platform system is provided. The casting platform system can be used for and/or within mounting on a boat and/or a boat dock. The casting platform system comprises a platform and a modular stability accessory. The platform comprises a base plate, at least one leg, and at least one attachment mechanism. The base plate defines an upper face and an opposite lower face. The at least one leg extends outwardly from the lower face of the base plate. The at least one leg supports the base plate above the boat/boat deck such that the lower face of the base plate faces an upper surface of the boat/boat deck. The at least one attachment mechanism is attached to the lower face of the base plate. The modular stability accessory includes at least one lateral member and at least one vertical member. The at least one lateral member is configured to be removably coupled to the at least one attachment mechanism of the platform. The at least one vertical member extends upwardly away from the at least one lateral member above the platform.

In some examples, the at least one attachment mechanism comprises a plurality of attachment mechanisms. The plurality of attachment mechanisms can be spaced apart from one another about the lower face of the base plate.

In some examples, the at least one lateral member comprises a pair of lateral members. The pair of lateral members can be spaced apart from one another. Each lateral member of the pair of lateral members can define a groove. Each lateral member of the pair of lateral members can be configured to be removably coupled to a corresponding one of the plurality of attachment mechanisms. In certain examples, the casting platform system can further comprise a plurality of locking mechanisms and a wire extending between and interconnecting the plurality of locking mechanisms. Each locking mechanism of the plurality of locking mechanisms can be received through a sidewall of a corresponding one of the plurality of attachment mechanisms. Each locking mechanism of the plurality of locking mechanisms can be configured to engage with the groove of a corresponding one of the pair of lateral members and to be moved out of engagement with the groove of the corresponding one of the pair of lateral members by displacing the wire.

In certain examples, the modular stability accessory can be a seat. The seat can comprise a pair of lateral members. The pair of lateral members can be spaced apart from one another. Each lateral member of the pair of lateral members can be configured to be removably coupled to a corresponding one of the plurality of attachment mechanisms. The seat can further comprise a pair of vertical members. The pair of vertical members can be spaced apart from one another. Each vertical member of the pair of vertical members can extend upwardly away from a corresponding lateral member of the pair of lateral members. The seat can further comprise a seat member. The seat member can be attached to each vertical member of the pair of vertical members. In examples, the seat member can include a seating surface and wings extending downwardly from the seating surface on opposing sides of the seating surface to form an inverted U-shape. In some examples, the seat can further comprise a cross bar extending between and interconnecting the pair of lateral members. In certain examples, the pair of vertical members can be collectively formed from a single continuous tube.

In other examples, the modular stability accessory can be a sissy bar. The sissy bar can comprise a pair of lateral members. The pair of lateral members can be spaced apart from one another. Each lateral member of the pair of lateral members can be configured to be removably coupled to a corresponding one of the plurality of attachment mechanisms. The sissy bar can further comprise a pair of vertical members. The pair of vertical members can be spaced apart from one another. Each vertical member of the pair of vertical members can extend upwardly away from a corresponding lateral member of the pair of lateral members. The sissy bar can further comprise a handle. The handle can be attached to each vertical member of the pair of vertical members. In examples, the handle can extend outwardly from each vertical member of the pair of vertical members. The handle can terminate in grips at opposing ends thereof. The sissy bar can comprise at least one cross beam. The at least one cross beam can extend between and interconnect the pair of vertical members. In some examples, the sissy bar can further comprise a cross bar extending between and interconnecting the pair of lateral members.

In further examples, the modular stability accessory can be a cage. The cage can comprise a pair of lateral members. The pair of lateral members can be spaced apart from one another. Each lateral member of the pair of lateral members can be configured to be removably coupled to a corresponding one of the plurality of attachment mechanisms. The cage can further comprise a first pair of vertical members. The first pair of vertical members can be spaced apart from one another. Each vertical member of the first pair of vertical members can extend upwardly away from a corresponding lateral member of the pair of lateral members. The cage can further comprise a second pair of vertical members. The second pair of vertical members can be spaced apart from one another. The second pair of vertical members can be spaced apart from each vertical member of the first pair of vertical members. Each vertical member of the second pair of vertical members can extend upwardly away from the platform. Each vertical member of the second pair of vertical members can be configured to be removably coupled to the platform. The cage can further comprise an arcuate member. The arcuate member can extend between and interconnect each vertical member of the first pair of vertical members and each vertical member of the second pair of vertical members to form a U-shape. The cage can further comprise a barrier member. The barrier member can be rotatably connected to the arcuate member. The barrier member can be configured to be selectively rotatable relative to the arcuate member between a closed position and an open position. In examples, the cage can further comprise a locking mechanism. The locking mechanism can be configured to be selectively movable between a locked position and an unlocked position. In the locked position, the locking mechanism can be configured to retain the barrier member in the closed position. In the unlocked position, the locking mechanism can be configured to permit the barrier member to be rotated away from the arcuate member into the open position. In examples, the base plate can further define a pair of first engagement features. Each vertical member of the second pair of vertical members can include a second engagement feature. Each of the second engagement features can be shaped complementary to a corresponding one of the pair of first engagement features. Each of the second engagement features can be configured to be removably coupled with a corresponding one of the pair of first engagement features. In examples, each of the second engagement features can be configured to be at least partially slidably received within a corresponding one of the pair of first engagement features, such that the modular stability accessory can be configured to be removably coupled to the platform via sliding engagement between each of the second engagement features and a corresponding one of the pair of first engagement features. Each first engagement feature of the pair of first engagement features can be a slot defined in the base plate and extending therethrough from the upper face to the lower face. Each of the second engagement features can be a protrusion extending outwardly away from a proximal end of the corresponding vertical member of the second pair of vertical members and configured to at least partially pass through and engage with a corresponding one of the slots defined in the base plate.

In some examples, the at least one attachment mechanism can define a receiving opening. The at least one lateral member can be configured to be at least partially slidingly received into the receiving opening.

In some examples, the at least one lateral member can comprise a sleeve member. The at least one lateral member can further comprise a rod member. The rod member can define a first end configured to be disposed within the sleeve member and fixedly attached to the at least one vertical member. The rod member can further define an opposite second end configured to be slidably disposed within the at least one attachment mechanism.

In an example, a boat is provided. The boat includes a deck and a casting platform system as described herein.

In another example, another casting platform system is provided. The casting platform system can be used for and/or within mounting on a boat and/or a boat dock. The casting platform system comprises a platform and a modular stability accessory. The platform comprises a base plate, a plurality of legs, and a pair of tubular attachment mechanisms. The base plate defines an upper face. The base plate further defines an opposite lower face. The plurality of legs are spaced apart from one another. Each leg of the plurality of legs extends outwardly from the lower face of the base plate. The plurality of legs support the base plate above the boat/boat deck such that the lower face of the base plate faces an upper surface of the boat/boat deck. Each attachment mechanism of the pair of attachment mechanisms is attached to the lower face of the base plate. Each attachment mechanism of the pair of attachment mechanisms defines a receiving opening. The modular stability accessory includes a pair of tubular lateral members, a cross bar, and plurality of locking mechanisms and a wire, a pair of tubular vertical members, and a stability member. Each lateral member of the pair of lateral members defines a groove and is configured to be at least partially slidingly receiving into the receiving opening of a corresponding attachment mechanism of the pair of attachment mechanisms of the platform. The cross bar extends between and interconnects the pair of lateral members. The wire extends between and interconnects the plurality of locking mechanisms. Each locking mechanism of the plurality of locking mechanisms is received through a sidewall of a corresponding one of the pair of attachment mechanisms and is configured to engage with the groove of a corresponding one of the pair of lateral members and to be moved out of engagement with the groove of the corresponding one of the pair of lateral members by displacing the wire. Each vertical member of the pair of vertical members extends upwardly away from a corresponding lateral member of the pair of lateral members above the platform. The stability member is attached to each vertical member of the pair of vertical members. The stability member is selected from the group consisting of a seat, a sissy bar, and a cage.

In a further example, a casting platform system is provided. The casting platform system can be used for and/or within mounting on a boat and/or a boat dock. The casting platform system includes a platform and a modular stability accessory. The platform includes a base plate, at least one leg, and at least one attachment mechanism. The base plate defines an upper face. The base plate further defines an opposite lower face. The base plate further defines a slot. The slot extends through the base plate from the upper face to the lower face. The at least one leg extends outwardly from the lower face of the base plate. The at least one leg supports the base plate above the boat/boat deck such that the lower face of the base plate faces an upper surface of the boat/boat deck. The at least one attachment mechanism is attached to the lower face of the base plate. The modular stability accessory includes at least one lateral member, at least one first vertical member, and at least one second vertical member. The at least one lateral member is configured to be removably coupled to the at least one attachment mechanism of the platform. The at least one first vertical member extends upwardly away from the lateral member above the platform. The at least one second vertical member includes a protrusion. The protrusion extends outwardly away from a proximal end of the at least one second vertical member. The protrusion is configured to be at least partially slidably received within the slot defined in the base plate.

An example of a casting platform system for mounting on a boat deck includes a support frame having a plurality of support legs and a casting platform that is removably attached to the support frame. The casting platform comprises a base plate and a support accessory extending from and supported above the base plate.

An example of a fishing boat described herein includes a deck, a support frame, and a casting platform. The support frame is supported above the deck by a plurality of support legs and includes a plurality of clamps. The casting platform has a base plate and a support accessory extending upward from the base plate. The base plate is removably attached to the support frame by the plurality of clamps.

An example of a method of using a casting platform system includes the steps of: attaching a first casting platform to a support frame; removing the first casting platform from the support frame; and attaching a second casting platform to the support frame. The support frame has a plurality of support legs, the first casting platform includes a first base plate and a first support accessory extending from the first base plate, and the second casting platform has a second base plate and a second support accessory extending from the second base plate.

Other portions of this disclosure will describe various alternative and complementary examples. As such, the foregoing summary is provided for purposes of example only, and should not be deemed in any way to limit the scope or spirit of the disclosure or claims.

### BRIEF DESCRIPTION OF DRAWINGS

The foregoing and other features of the present disclosure will become more fully apparent from the following description, taken in conjunction with the accompanying drawings. These drawings depict only several exemplary embodiments in accordance with the disclosure and, therefore, are not to be considered limiting its scope. The disclosure will be described with additional specificity and detail through use of the accompanying drawings. In the drawings:

FIG. 1 illustrates an upper front perspective view of a platform mounted on a boat according to one example;

FIG. 2A illustrates an upper rear perspective view of the platform of FIG. 1;

FIG. 2B illustrates an upper front perspective view of a portion of the platform of FIG. 1 including an engagement feature in the form of a slot defined by the platform;

FIG. 3 illustrates a lower front perspective view of the platform of FIG. 1;

FIG. 4A illustrates a perspective view showing a means of attaching a leg to the platform of FIG. 1 according to one example;

FIG. 4B illustrates another perspective view showing a means of attaching a leg to the platform of FIG. 1 according to one example;

FIG. 5A illustrates a side view showing a means of attaching a modular stability accessory to the platform of FIG. 1 according to one example;

FIG. 5B illustrates an upper front perspective view of a portion of the modular stability accessory of FIG. 5A according to one example;

FIG. 6 illustrates an upper rear perspective view of a casting platform system employing a modular stability accessory in the form of a seat according to one example with the seat detached from the platform;

FIG. 7 illustrates an upper rear perspective view of the casting platform system of FIG. 6 with the seat attached to the platform;

FIG. 8 illustrates an upper rear perspective view of a casting platform system employing a modular stability accessory in the form of a sissy bar according to one example with the sissy bar attached to the platform;

FIG. 9 illustrates an upper perspective rear view of a casting platform system employing a modular stability accessory in the form of a cage according to one example with the cage detached from the platform and with a portion of the cage rotated into a closed position;

FIG. 10 illustrates an upper rear perspective view of the casting platform system of FIG. 9 with the cage attached to the platform and with the portion of the cage rotated into a closed position;

FIG. 11 illustrates an upper front perspective view of the casting platform system of FIG. 9 with the cage attached to the platform and with the portion of the cage rotated into an open position;

FIG. 12 illustrates a lower front perspective view of the casting platform system of FIG. 9 with the cage attached to the platform;

FIG. 13A illustrates a side cross-sectional view showing a means of attaching a modular stability accessory to the platform of FIG. 1 according to one example with a lateral member of the modular stability accessory partially slidably disposed within an attachment mechanism of the platform;

FIG. 13B illustrates a side cross-sectional view of the means of FIG. 13A according to one example with the lateral member of the modular stability accessory fully slidably disposed within the attachment mechanism of the platform; and

FIG. 13C illustrates a perspective view showing a means of employing a locking mechanism received through a sidewall of an attachment mechanism according to one example;

FIG. 14 is a top perspective view of an implementation of a casting platform;

FIG. 15 is a bottom perspective view of the casting platform of FIG. 14;

FIG. 16 is a top view of the casting platform of FIG. 14;

FIG. 17 is a bottom view of the casting platform of FIG. 14;

FIG. 18 is a front view of the casting platform of FIG. 14;

FIG. 19 is a side view of the casting platform of FIG. 14;

FIG. 20 is an enlarged detail view of area 15 of FIG. 15;

FIG. 21 is a bottom perspective exploded view of the casting platform of FIG. 14;

FIG. 22 is a top perspective view of the casting platform of FIGS. 14-21 attached to a boat deck; and

FIG. 23 is a cross-sectional view of the casting platform of FIGS. 14-21 attached to the boat deck.

### DETAILED DESCRIPTION

The present disclosure may be understood more readily by reference to the following detailed description of desired embodiments and the examples included therein. In the following specification and the claims which follow, reference will be made to a number of terms which shall be defined to have the following meanings.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

The term “comprising” is used herein as requiring the presence of the named component and allowing the presence of other components. The term “comprising” should be construed to include the term “consisting of,” which allows the presence of only the named component, along with any impurities that might result from the manufacture of the named component.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 inches to 10 inches” is inclusive of the endpoints, 2 inches and 10 inches, and all the intermediate values). The endpoints of the ranges and any values disclosed herein are not limited to the precise range or value; they are sufficiently imprecise to include values approximating these ranges and/or values.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range of “from about 2 to about 10” also discloses the range “from 2 to 10.”

The terms “substantially” and “about” can be used to include any numerical value that can vary without changing the basic function of that value. When used with a range, “substantially” and “about” also disclose the range defined by the absolute values of the two endpoints, e.g. “about 2 to about 4” also discloses the range “from 2 to 4.” The terms “substantially” and “about” may refer to plus or minus 10% of the indicated number.

The present disclosure may refer to components as having a length, width, height, and thickness. It is noted that “length” and “width” are used interchangeably herein, or put another way, these terms refer to the same dimension or axis.

It should be noted that many of the terms used herein are relative terms. For example, the terms “upper” and “lower” are relative to each other in location, i.e. an upper component is located at a higher elevation than a lower component in a given orientation, but these terms can change if the device is flipped. The terms “horizontal” and “vertical” are used to indicate direction relative to an absolute reference, i.e. ground level. The terms “above” and “below,” or “upwards” and “downwards” are also relative to an absolute reference; an upwards flow is always against the gravity of the earth.

The term “parallel” should be construed in its lay term as two edges or faces generally continuously having the same distance between them, and should not be strictly construed in mathematical terms as requiring that the two edges or faces cannot intersect when extended for an infinite distance. Similarly, the term “planar” should not be strictly construed as requiring that a given surface be perfectly flat.

The current disclosure describes casting platform systems for fishing boats or boat docks and modular stability accessories for improving the experience of fishermen that overcome the drawbacks of prior systems and accessories. As will be appreciated, the casting platform systems could also be employed in other environments.

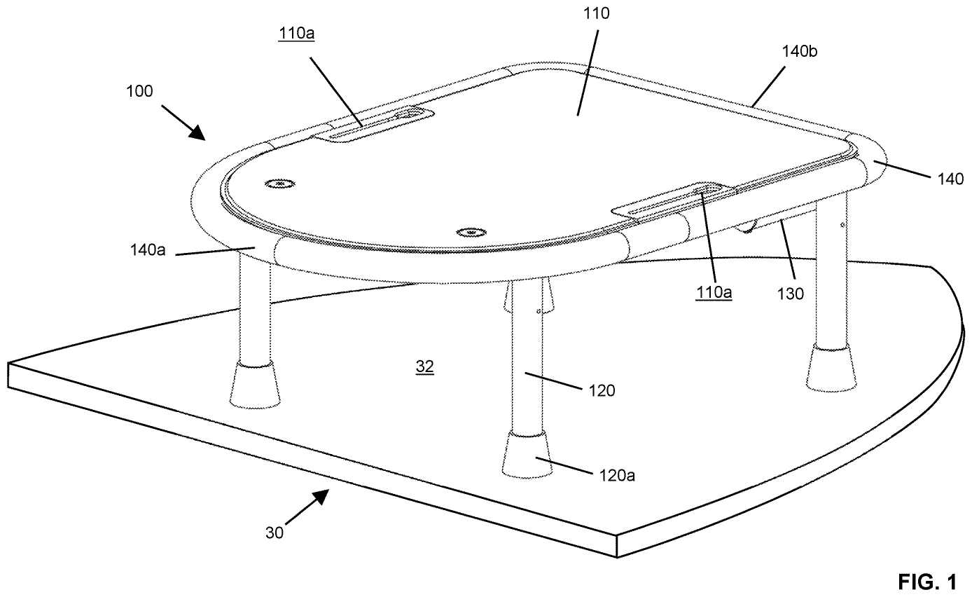

FIGS. 1-3 illustrate a platform 100 according to one example of the current disclosure. The platform 100 is generally configured to be mounted on a deck 30 of a boat, such as is illustrated in FIG. 1, although it will be appreciated that the platform 100 can be used on any desirable surface (e.g., a boat deck, the shore). The platform 100 can generally be configured to be mounted on the deck 30 of the boat by any suitable means, such as by employing a turnbuckle or similar attachment component. The platform 100 includes a base plate 110, one or more legs 120, and one or more attachment mechanisms 130.

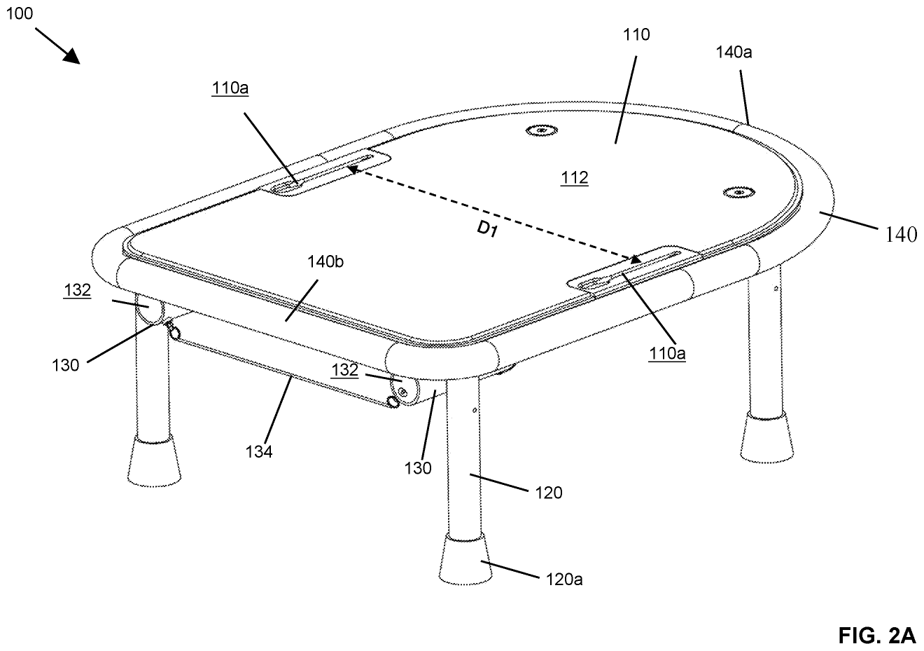

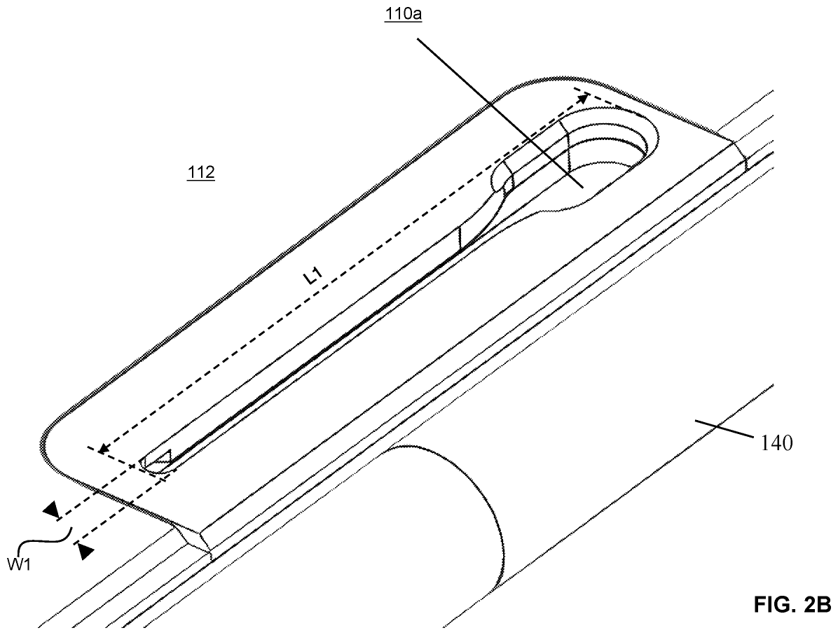

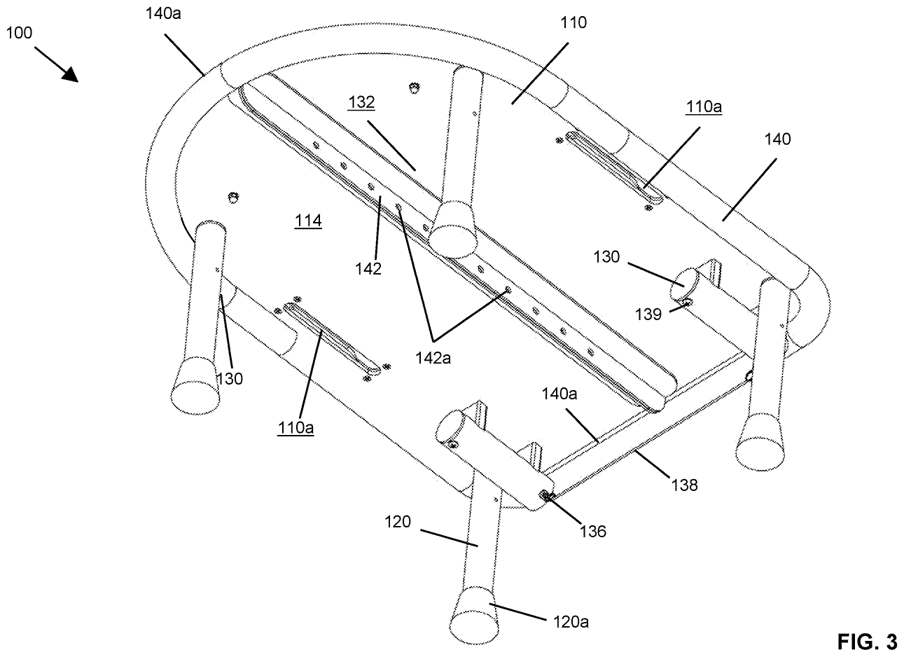

The base plate 110 is generally configured to provide a flat elevated surface upon which a fisherman can stand. The base plate 110 generally defines an upper face 112 (refer to FIG. 1) and an opposite lower face 114 (refer to FIG. 2A and FIG. 3). In certain examples, a frame 140 can extend about a perimeter of the base plate 110. The frame 140 can extend from a forward end 140a to an opposite rear end 140b thereof.

In some examples, the frame 140 can include a center beam 142. The center beam 142 can generally extend between the forward end 140a and the rear end 140b of the frame 140. In examples, the center beam 142 can be positioned between respective left-side and right-side legs 120 of the platform 100. The center beam 142 can generally be configured to provide structure and rigidity to the base plate 110 of the platform 100. The center beam 142 can, in certain examples, include one or more attachment points 142a (e.g., in the form of apertures) for at least partially receiving a securing member (not shown, e.g., tiedown strap, chain, line) for removably connecting the center beam 142 to another structure or object (e.g., the boat deck 30).

The base plate 110 can be of any suitable size, shape, and/or material as desired to suit a particular application. By way of non-limiting example, the base plate 110 can have a bullet shape. By way of further non-limiting example, the base plate 110 can have a length of about 30 inches as measured between the forward end 140a and the rear end 140b. By way of further non-limiting example, the base plate 110 can be formed from a marine-grade and/or corrosion-resistant material, such as a metal plate or carbon fiber, and the frame 140 can be tubular in shape. By way of further non-limiting example, the upper face 112 of the base plate 110 and/or the frame 140 of the platform 100 can include a rubberized or otherwise high-friction coating or surface or a protective coating or surface to improve the stability, longevity, and comfort of the fisherman using the platform 100.

One or more legs 120 can be provided that are generally configured to elevate and/or support the base plate 110 above the boat deck 30. As illustrated in FIG. 1, the base plate 110 can be elevated and/or supported above the boat deck 30 such that the lower face 114 of the base plate 110 faces an upper surface 32 of the boat deck 30. Each leg of the one or more legs 120 extends outwardly away from the lower face 114 of the base plate 110 (e.g., toward the boat deck 30 when provided). Each leg 120 can, in some examples, include a foot 120a. The foot 120a can be made of the same or a different material as the leg 120, and the foot 120a can prevent marring or other undesirable contact between the leg 120 and the boat deck 30. In examples, the leg(s) 120 can be removably mounted to (e.g., rested upon) the boat deck 30. In other examples, the leg(s) 120 can be fastened or otherwise attached to the boat deck 30.

The leg(s) 120 can be of any suitable number, size, shape, and/or material as desired to suit a particular application. In the example illustrated in FIGS. 1-3, the platform 100 includes a total of four legs 120, although other examples are not so limited. When multiple legs 120 are provided, the legs 120 can generally be spaced apart from one another about the lower face 114 of the base plate 110. The leg(s) 120 can generally be attached (e.g., fastened, clamped, welded) to the lower face 114 of the base plate 110. By way of further non-limiting example, the leg(s) 120 can have a length of from about 12 inches to about 20 inches, such that the base plate 110 is elevated from about 12 inches to about 20 inches above the boat deck 30. In certain examples, the leg(s) 120 can be adjustable in length (e.g., in the form of telescoping legs). By way of further non-limiting example, the leg(s) 120 can be formed from a marine-grade and/or corrosion-resistant material, such as a metal or carbon fiber, and the leg(s) 120 can be tubular in shape.

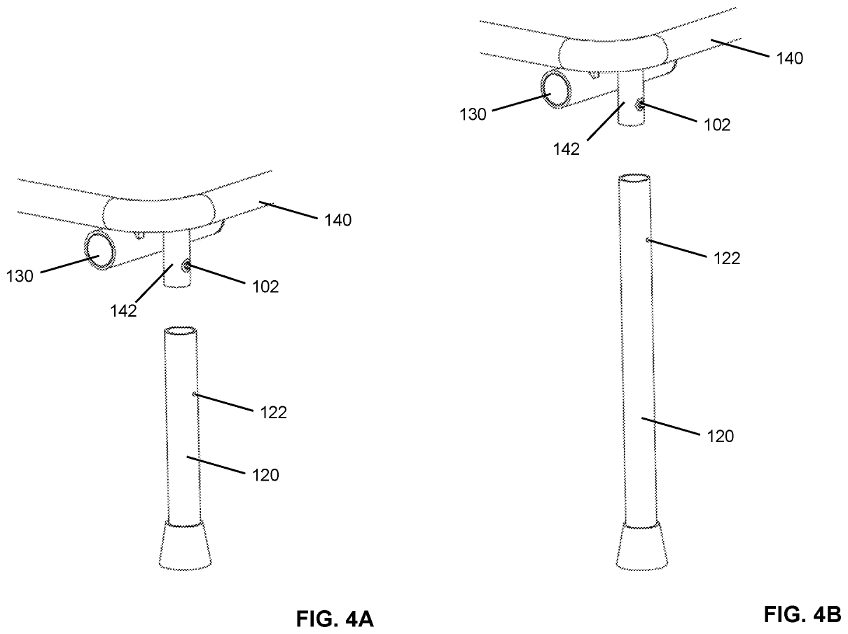

Turning to FIG. 4A and FIG. 4B, in certain examples, the platform 100 can include means for removably connecting the leg(s) 120 thereto. For example, the platform 100 can include a first engagement feature 102 (e.g., a biased pin or hole), and the leg(s) 120 can include a second engagement feature 122 (e.g., a biased pin or hole) shaped complementary to the first engagement features 102 of the platform 100 and configured to engage therewith to removably connect the leg(s) 120 to the platform 100, such as is illustrated in FIG. 4A and FIG. 4B. In this way, multiple different legs 120 (e.g., of differing sizes, shapes, and/or materials) can be selected for connection with the platform 100 as desired to suit a particular application. The modularity of the platform 100 and the interchangeability of the leg(s) 120 advantageously allows for the purchase of a single platform 100 and any desirable number of leg(s) 120 (e.g., having different lengths) that can each be used with the platform 100 to suit different applications or uses.

In some examples, the platform 100 can define one or more engagement features, which can be in the form of or include slots 110a that are generally configured to operatively interconnect the platform 100 to a selected modular stability accessory 200, as described herein. The slot(s) 110a can generally extend through the platform 100 from the upper face 112 thereof to the lower face 114 thereof, such as is illustrated in FIGS. 1-3. The slot(s) 110a can generally be configured to releasably engage with a portion (e.g., a complementary engagement feature) of a selected modular stability accessory 200, as described herein. As illustrated in FIGS. 1-3, the slot(s) 110a are defined through the base plate 110 immediately adjacent the frame 140 at opposing side edges of the base plate 110. Defining the slot(s) 110a immediately adjacent the frame 140 at opposing side edges of the base plate 110 can help ensure that the slot(s) 110a and any other features engaged therewith do not interfere with the fisherman standing upon the base plate 110 (i.e., the upper face 112 thereof).

The slot(s) 110a can be of any suitable number, size, shape, and/or material as desired to suit a particular application. In the example illustrated in FIGS. 1-3, the platform 100 includes a total of two slots 110a (i.e., a pair of slots 110a), although other examples are not so limited. When multiple slots 110a are provided, the slots 110a can generally be spaced apart from one another about the base plate 110. By way of non-limiting example, as illustrated in FIG. 2A, when a pair of slots 110a are provided, a first one of the pair of slots 110a can be spaced apart from a second one of the pair of slots 110a by a distance D1 of about 20 inches. By way of further non-limiting example, as illustrated in FIG. 2B, the slot(s) 110a can have a length L1 of about 6 inches and/or a width W1 of about 0.325 inches. By way of further non-limiting example, the slot(s) 110a can be elongate in shape.

One or more attachment mechanisms 130 can be provided that are generally configured to operatively attach a selected modular stability accessory 200 to the platform 100, as described herein. As illustrated in FIG. 3, the attachment mechanisms(s) 130 are attached to the lower face 114 of the base plate 110. Attaching the attachment mechanisms(s) 130 to the lower face 114 of the base plate 110 can help ensure that the attachment mechanisms(s) 130 do not interfere with the fisherman standing upon the base plate 110 (i.e., the upper face 112 thereof). In examples, the attachment mechanisms(s) 130 can be positioned between a leg 120 of the platform 100 and the center beam 142. The attachment mechanisms(s) 130 can be attached to the lower face 114 of the base plate 110 by any suitable means. By way of non-limiting example, each attachment mechanism 130 can define one or more apertures for receiving a fastener that attaches the attachment mechanism 130 to the base plate 110 (e.g., via threaded or non-threaded apertures formed in the lower face 114 of the base plate 110). In other examples, the attachment mechanism 130 can be welded, clamped, or otherwise attached to the base plate 110.

The attachment mechanisms(s) 130 can be of any suitable number, size, shape, and/or material as desired to suit a particular application. In the example illustrated in FIG. 3, the platform 100 includes a total of two attachment mechanisms 130 (i.e., a pair of attachment mechanisms 130), although other examples are not so limited. When multiple attachment mechanisms 130 are provided, the attachment mechanisms 130 can generally be spaced apart from one another about the lower face 114 of the base plate 110. By way of non-limiting example, when a pair of attachment mechanisms 130 are provided, a first one of the pair of attachment mechanisms 130 can be spaced apart from a second one of the pair of attachment mechanisms 130 by about 14 inches. By way of further non-limiting example, the attachment mechanism(s) 130 can have a length of about 12 inches. By way of further non-limiting example, the attachment mechanism(s) 130 can be formed from a marine-grade and/or corrosion-resistant material, such as a metal or carbon fiber, and the attachment mechanism(s) 130 can be tubular in shape.

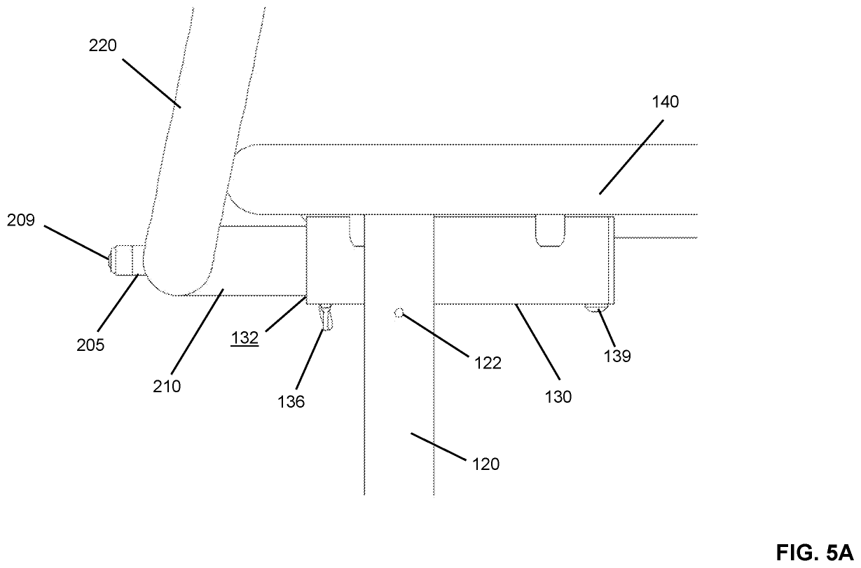

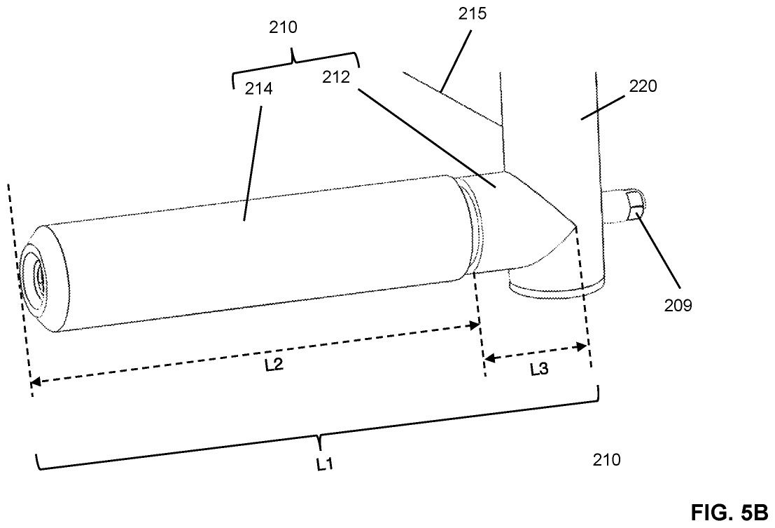

Turning now to FIG. 5A, a means is illustrated for attaching the modular stability accessory 200 to the platform 100 according to one example to form a casting platform system 10, as described herein. The modular stability accessory 200 includes one or more lateral members 210 and one or more vertical members 220, as described herein.

One or more lateral members 210 can be provided that are generally configured to be removably coupled with corresponding ones of the attachment mechanism(s) 130. As illustrated, the lateral member(s) 210 can generally extend proximate the rear end 140b toward the forward end 140a of the base plate 110 along a portion of the lower face 114 of the base plate 110. As can be best seen in FIG. 5A, each lateral member 210 can be configured to be at least partially slidingly received into a corresponding attachment mechanism 130. For example, each attachment mechanism 130 can define a receiving opening 132 into which a corresponding lateral member 210 can be at least partially slidingly received. Each lateral member 210 can also be configured to be removably attached to the attachment mechanism 130, as further described herein. For example, a locking mechanism (e.g., ball detent pin, plunger, clamp, handle or similar device) can be received through a sidewall of each attachment mechanism 130 to engage with a corresponding lateral member 210 (e.g., a groove defined thereby). In the example illustrated herein, the locking mechanism is a plunger 136, but other examples are not necessarily so limited. As further described herein, the plunger 136 can be selectively moved into and out of engagement with the corresponding lateral member 210, thereby selectively and respectively removably attaching and detaching the modular stability accessory 200 to and from the platform 100.

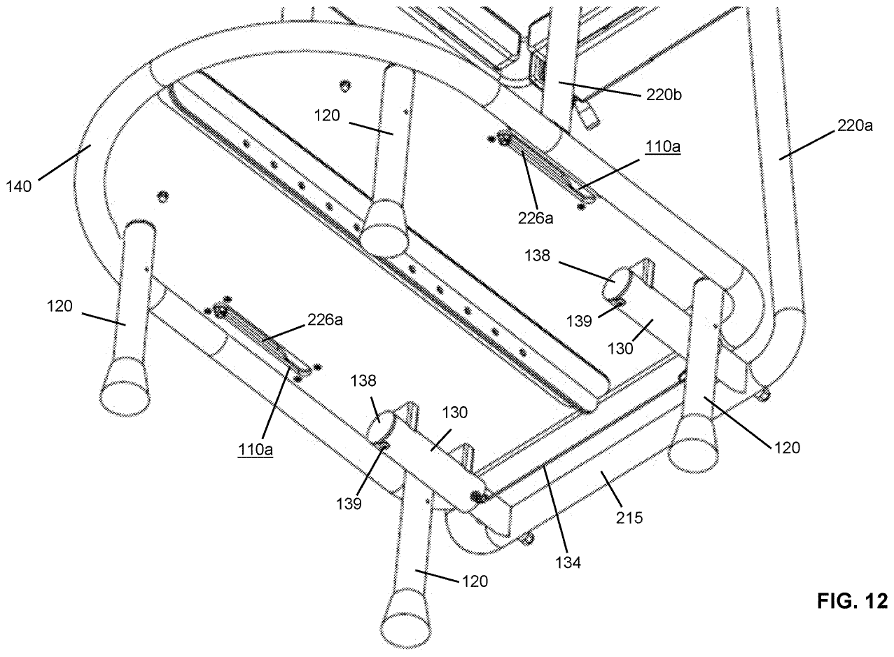

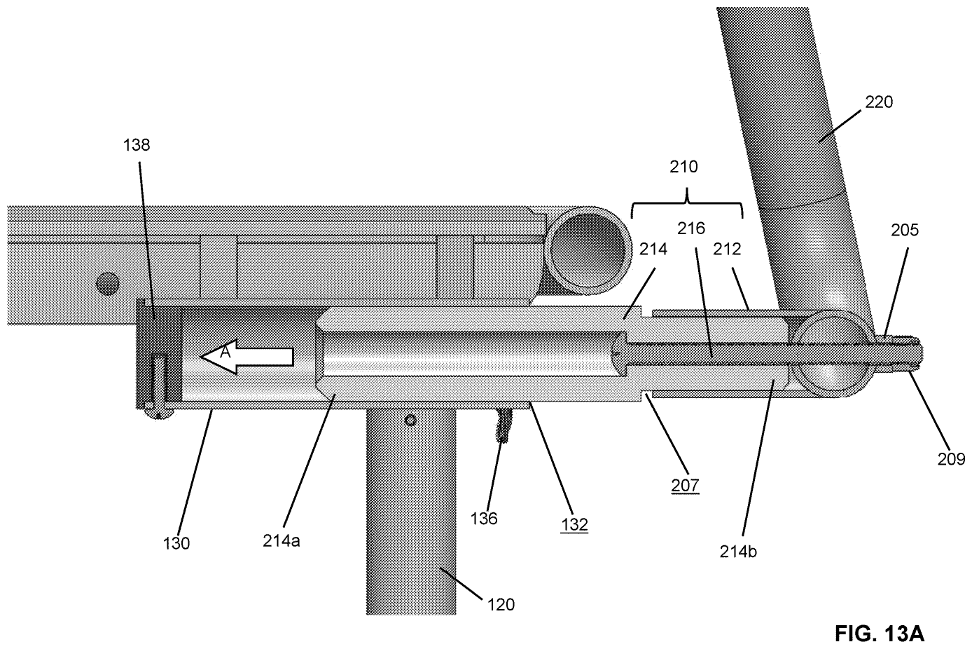

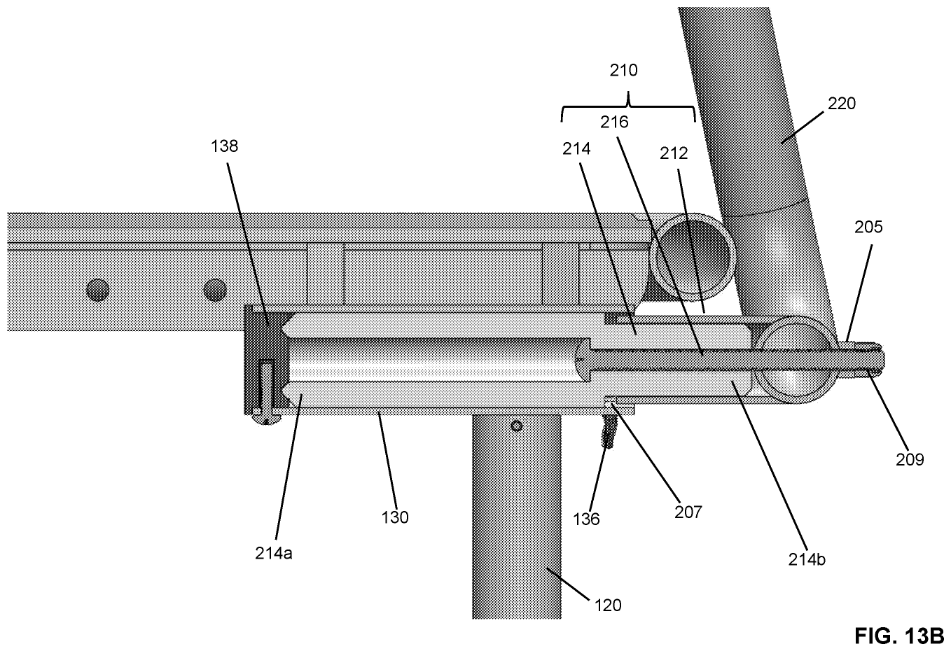

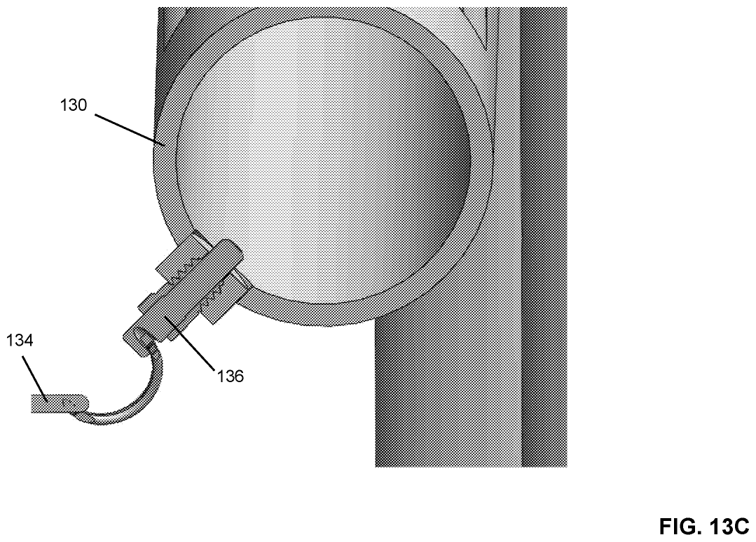

With reference now to FIG. 13A and FIG. 13B, the lateral member(s) 210 can, in certain cases, be defined by a plurality of components. For example, the lateral member(s) 210 can include a sleeve member 212. In examples, the sleeve member 212 can be CNC-machined and welded to a corresponding vertical member 220, which can advantageously obviate the need for matching a notched/compound bended lateral member and vertical member. The lateral member(s) 210 can also include a rod member 214. In examples, the rod member 214 defines a groove 207 (e.g., recess, notch) proximate the second end 214b thereof. The rod member 214 can define a first end 214a and an opposite second end 214b. As illustrated in FIG. 13A and FIG. 13B, the first end 214a of the rod member 214 can be configured to be disposed within the sleeve member 212 (and, in some cases, a portion of the vertical member 220), and the second end 214b of the rod member 214 can be configured to be disposed within the attachment mechanism 130 when the modular stability accessory 200 is attached to the platform 100. In examples, the rod member can be formed from an ultra-high molecular weight (UHMW) plastic or similar material. The lateral member(s) 210 can further include a fastener 216. In examples, the fastener 216 can pass through the rod member 214 (i.e., from the first end 214a to the second end 214b thereof). In certain examples, the fastener 216 can also pass through (e.g., transect) the vertical member 220 and engage with (e.g., via threads) a stopper 209 (e.g., a nut) after passing through an appropriately sized spacer 205, which are also shown in FIG. 5A. Additionally or alternatively, in some examples, a spacer (not shown) can be provided within the sleeve member 212 and configured to abut a portion (e.g., the first end 210a) of the rod member 214, such as to accommodate larger angles between the vertical member 220 and the lateral member 210. With continued reference to FIG. 13A and FIG. 13B, the attachment mechanism 130 can include an end cap 138, such as a plastic or rubber insert, configured to be at least partially inserted into the distal end of the attachment mechanism, and the end cap 138 can be secured to the attachment mechanism 130 by a fastener 139 passing through a sidewall of the attachment mechanism 130 and at least partially into the end cap 138 (refer also to FIG. 3 and FIG. 12).

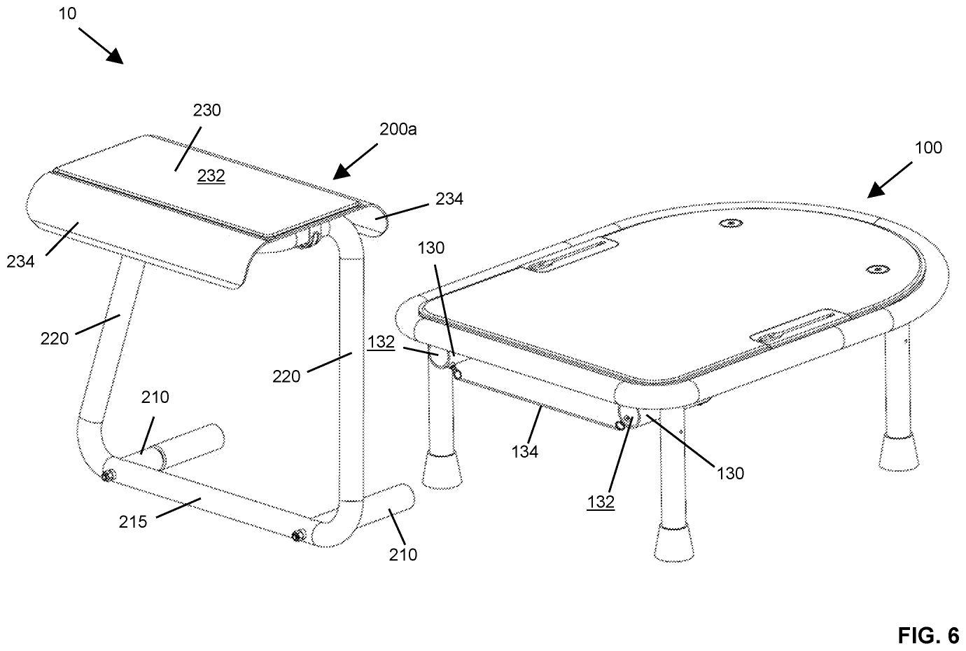

The lateral member(s) 210 can be of any suitable number, size, shape, and/or material as desired to suit a particular application. In the examples illustrated in FIGS. 6-12, the modular stability accessory 200 includes a total of two lateral members 210 (i.e., a pair of lateral members 210), although other examples are not so limited. The number of lateral members 210 generally corresponds to the number of attachment mechanisms 130. When multiple lateral members 210 are provided, the lateral members 210 can generally be spaced apart from one another. By way of non-limiting example, as illustrated in FIG. 5B, the lateral member(s) 210 can have a length L1 of about 8 inches, with the sleeve member 212 having a length L2 of about 2.5 inches and the rod member 214 having a length L3 of about 5.5 inches. By way of further non-limiting example, the lateral member(s) 210 can be formed from a marine-grade and/or corrosion-resistant material, such as a metal or carbon fiber, and the lateral member(s) 210 can be tubular in shape.

In examples, the lateral members 210 can be interconnected by a cross bar 215 extending therebetween. In this way, the cross bar 215 can provide stability and/or structural rigidity.

As illustrated in FIG. 5A, one or more vertical members 220 can extend upwardly away from the one or more lateral members 210 above the platform 100. The vertical member(s) 220 can be connected (e.g., welded, fastened, clamped) to the lateral member(s) 210 or can be formed integrally with the lateral member(s) 210. In some examples, such as is illustrated herein, a pair of vertical members 220 can be collectively formed from a single continuous tube, such as a tube that is bent to form the desired shape without any welds or breaks along the entire length of the tube, although other examples are not necessarily so limited. The vertical member(s) 220 are generally configured to support (e.g., via attachment thereto) a stability member (e.g., a seat 200a, a sissy bar 200b, a cage 200c, 200d) above the platform as described herein.

The vertical member(s) 220 can be of any suitable number, size, shape, and/or material as desired to suit a particular application. In the examples illustrated in FIGS. 6-12, the modular stability accessory 200 includes a total of two vertical members 220 (i.e., a pair of vertical members 220), although other examples are not so limited. When multiple vertical members 220 are provided, the vertical members 220 can generally be spaced apart from one another. By way of non-limiting example, the vertical member(s) 220 can have a length of about 30 inches, such that the stability member is elevated about 30 inches above the platform 100. In certain examples, the vertical member(s) 220 can be adjustable in length (e.g., in the form of telescoping members). By way of further non-limiting example, the vertical member(s) 220 can be formed from a marine-grade and/or corrosion-resistant material, such as a metal or carbon fiber, and the vertical member(s) 220 can be tubular in shape.

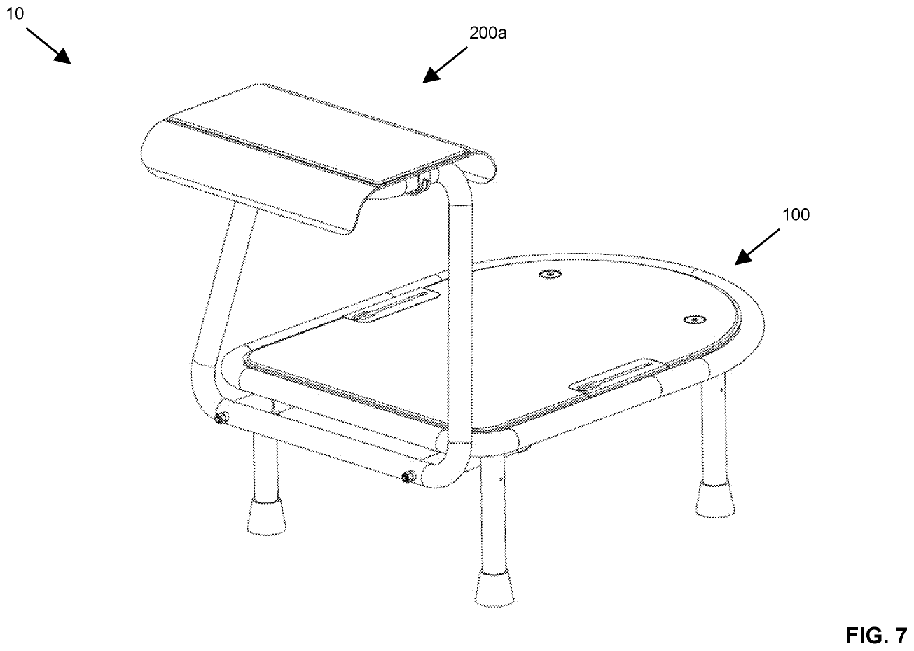

With reference to FIG. 6 and FIG. 7, a casting platform system 10 employing a modular stability accessory 200 in the form of a seat 200a is illustrated according to one example. The seat 200a includes a pair of lateral members 210 and a pair of vertical members 220 as described above, with the lateral members 210 spaced apart from one another and the vertical members 220 spaced apart from one another. The seat 200a also includes a cross bar 215 extending between and interconnecting the pair of lateral members 210. The seat 200a further includes a seat member 230. The seat member 230 is attached to each of the vertical members 220. The seat member 230 can be attached (e.g., fastened, clamped, welded) to each of the vertical members 220 by any suitable means. The seat member 230 can, in certain examples, include a seating surface 232 for supporting a fisherman thereon. The seat member 230 can further include wings 234. The wings 234 can extend downwardly from the seating surface 232 on opposing sides of the seating surface 232. The seating surface 232 and the wings 234 extending downwardly therefrom can form an inverted U-shape.

The seat 200a can be of any suitable size, shape, and/or material as desired to suit a particular application. By way of non-limiting example, the vertical members 220 of the seat 200a can have a length of about 24 inches, such that the seat member 230 is elevated about 24 inches above the platform 100. By way of further non-limiting example, the seating surface 232 and wings 234 can be made from the same material as the base plate 110 of the platform 100. By way of further non-limiting example, the seating surface 232 and/or the wings 234 of the seat member 230 can include a rubberized or otherwise high-friction coating or surface or a protective coating or surface to improve the stability, longevity, and comfort of the fisherman using the seat 200a.

With continued reference to FIG. 6 and FIG. 7, the seat 200a can be removably coupled to the platform 100. In this regard, a fisherman can selectively couple and decouple the seat 200a from the platform 100, as desired, which allows the fisherman to modularly use the casting platform system 10 as desired to suit a particular application. According to one example, a pair of attachment mechanisms 130 can be attached to the lower face 114 of the base plate 110 of the platform 100. One of a pair of lateral members 210 can then be removably coupled to a corresponding first one of the attachment mechanisms 130, and the other of the pair of lateral members 210 can then be removably coupled to a corresponding second one of the attachment mechanisms 130. In certain examples, each of the lateral members 210 can be at least partially slid into a corresponding receiving opening 132 of the corresponding attachment mechanism 130. The lateral members 210 can be secured within the corresponding attachment mechanisms via engagement between the corresponding plungers 136 and the lateral members 210, as described herein. Although the example illustrated in FIG. 6 and FIG. 7 relies on the foregoing method of attachment (which is also described with respect to FIGS. 5A, 13A, and 13B), other examples for removably coupling the seat 200a to the platform 100 are not so limited, and it is to be understood that the attachment means described with respect to FIG. 6 and FIG. 7 could be applied to any modular support accessory.

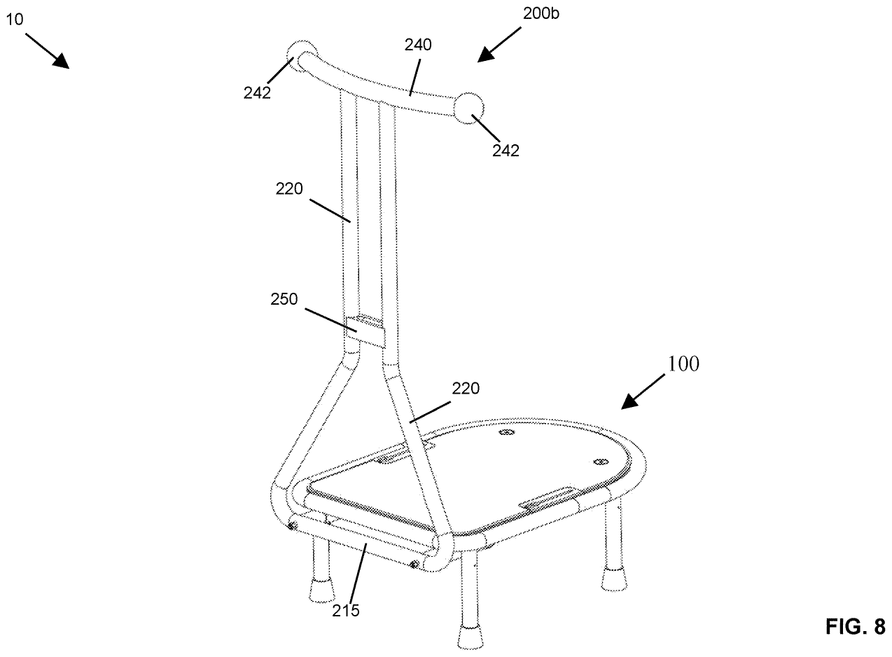

Turning to FIG. 8, a casting platform system 10 employing a modular stability accessory 200 in the form of a sissy bar 200b is illustrated according to one example. The sissy bar 200b includes a pair of lateral members 210 and a pair of vertical members 220 as described above, with the lateral members 210 spaced apart from one another and the vertical members 220 spaced apart from one another. The sissy bar 200b also includes a cross bar 215 extending between and interconnecting the pair of lateral members 210. The sissy bar 200b further includes a handle 240. The handle 240 is attached to each of the vertical members 220. The handle 240 can be attached (e.g., fastened, clamped, welded) to each of the vertical members 220 by any suitable means. The handle 240 can, in certain examples, extend outwardly from each vertical member 220 for providing an area for the fisherman to hold. The handle 240 can terminate in one or more grips 242 at the opposing ends thereof, such as is illustrated in FIG. 8. In examples, the sissy bar 200b can include one or more cross beams 250. The cross beam(s) 250 can extend between and interconnect the vertical members 220. The sissy bar 200b can be removably coupled to the platform 100 in the same way as previously described with respect to the seat 200a (i.e., by removably coupling the lateral members 210 to corresponding attachment mechanisms 130). Although the example illustrated in FIG. 8 relies on the foregoing method of attachment (which is also described with respect to FIGS. 5A, 13A, and 13B), other examples for removably coupling the sissy bar 200b to the platform 100 are not so limited, and it is to be understood that the attachment means described with respect to FIG. 8 could be applied to any modular support accessory.

In some examples, the vertical members 220 of the sissy bar 200b can extend upwardly away from respective lateral members 210 toward one another, such that the sissy bar 200b has a first width at its lower end (i.e., proximate the attachment mechanisms 130) that is greater than a second width at its upper end (i.e., proximate the handle 240). In particular examples, the vertical members 220 of the sissy bar 200b can extend upwardly away from respective lateral members 210 toward one another until reaching a lower cross beam 250 and can then extend substantially parallel one another from the lower cross beam 250 towards the handle 240. In examples, the sissy bar 200b can include a cupholder (not shown).

The sissy bar 200b can be of any suitable size, shape, and/or material as desired to suit a particular application. By way of non-limiting example, the vertical members 220 of the sissy bar 200b can have a length of about 38 inches, such that the handle 240 is elevated about 38 inches above the platform 100. By way of further non-limiting example, the sissy bar 200b can be formed from a marine-grade and/or corrosion-resistant material, such as a metal or carbon fiber, and the grips 242 can be made from a different material.

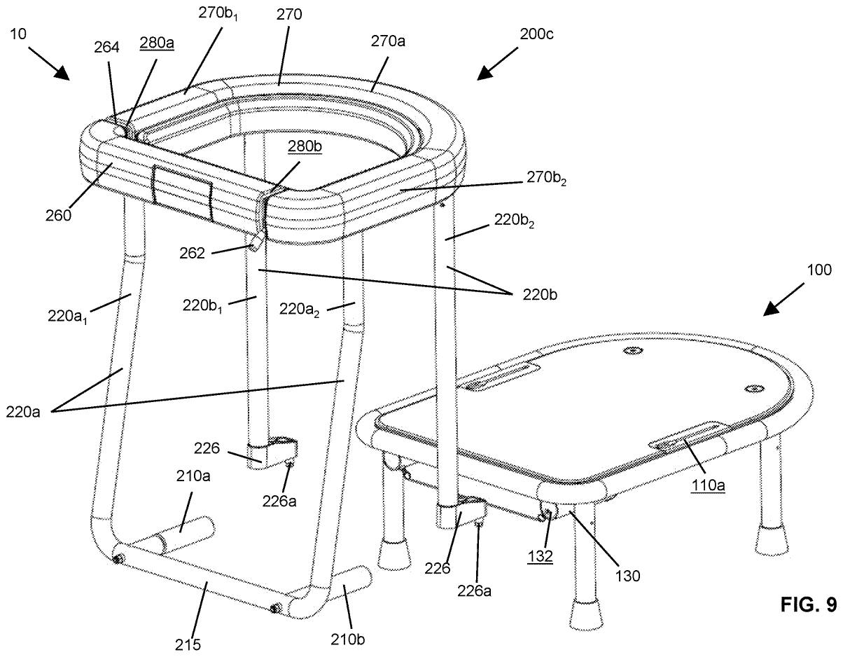

Next, FIGS. 9-12 illustrate a casting platform system 10 employing a modular stability accessory 200 in the form of a cage 200c, according to one example. The cage 200c includes a pair of lateral members 210 as described above, with the lateral members 210 spaced apart from one another. The cage 200c also includes a cross bar 215 extending between and interconnecting the pair of lateral members 210. The cage 200c further includes a first pair of vertical members 220a as described above, with the vertical members 220a spaced apart from one another. Each vertical member of the first pair of vertical members 220a extends upwardly away from a corresponding lateral member 210. The cage 200c further includes a second pair of vertical members 220b, with the vertical members 220b spaced apart from one another and from the first pair of vertical members 220a. Each vertical member of the second pair of vertical members 220b extends upwardly away from the platform 100. Each vertical member of the second pair of vertical members 220b is configured to be removably coupled to the platform 100, as described herein.

The cage 200c further includes an arcuate member 270. The arcuate member 270 extends between and interconnects each vertical member 220a₁, 220a₂ of the first pair of vertical members 220a and each vertical member 220b₁, 220b₂ of the second pair of vertical members 220b. The arcuate member 270 generally includes an arcuate base portion 270a extending in a circumferential direction and two leg portions 270b₁, 270b₂, such that the arcuate member 270 generally forms a U-shape. The arcuate base portion 270a of the arcuate member 270 generally extends between and interconnects a first one of the leg portions 270b₁ and a second one of the leg portions 270b₂. The first leg portion 270b₁ is generally connected to a first vertical member 220a₁ of the first pair of vertical members 220a and extends toward a second vertical member 220a₂ of the first pair of vertical members 220a, and the second leg portion 270b₂ is generally connected to a first vertical member 220b₂ of the second pair of vertical members 220b and extends toward a second vertical member 220b₂ of the second pair of vertical members 220b.

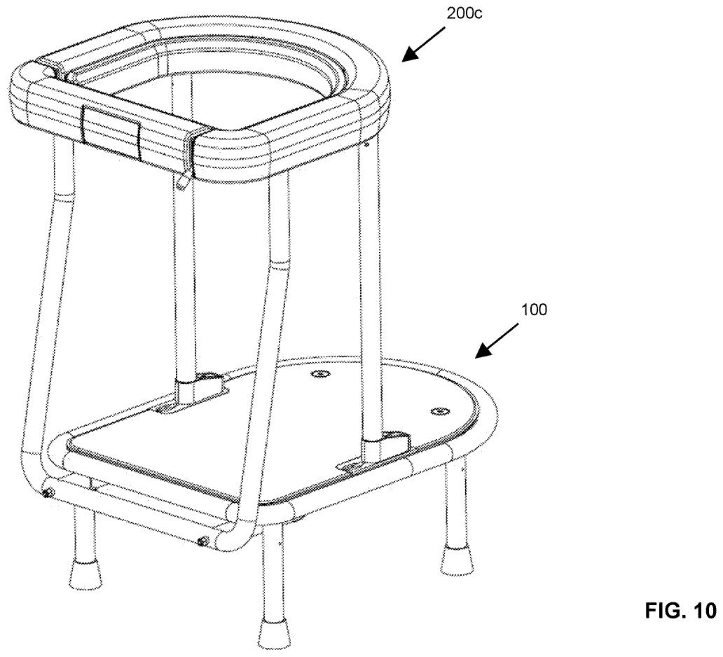

The cage 200c further includes a barrier member 260. The barrier member 260 is rotatably connected to the arcuate member 270. The barrier member 260 and the arcuate member 270 collectively form a closed U-shape when the barrier member is in the closed position (refer to FIG. 9 and FIG. 10) except for gaps between the barrier member 260 and the arcuate member 270, such as: (i) a first gap 280a between a first end of the barrier member 260 and the first leg portion member 270b₁ of the arcuate member 270; and (ii) a second gap 280b between an opposite second end of the barrier member 260 and the second leg portion member 270b₂ of the arcuate member 270. In examples, the barrier member 260, the arcuate member 270, and/or other portions of the cage 200c can include cushions to provide added comfort to the fisherman using the cage 200c.

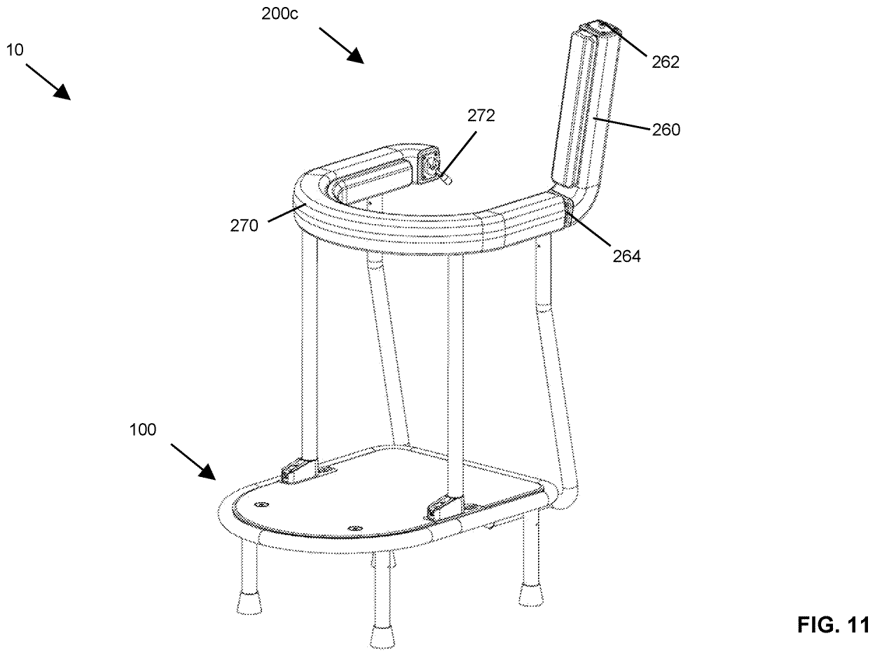

In certain examples, the barrier member 260 can be rotatably connected to the arcuate member 270 at a rotation point 264, such as for more conveniently allowing a fisherman to step into and out of the cage 200c. As can be appreciated, the barrier member 260 can thus be configured to be at least partially rotatable, such as by rotating the barrier member 260 away from the arcuate member 270 as illustrated in FIG. 11. In examples, the barrier member 260 can be rotatable at least 90°. In certain examples, the barrier member 260 can be rotatable at least 135°.

In some examples, the barrier member 260 can be selectively rotatable between a closed (i.e., non-rotated) position, such as the position illustrated in FIG. 9 and FIG. 10, and an open (i.e., rotated) position, such as the position illustrated in FIG. 11. In examples, the barrier member 260 can be configured to be locked, latched, or otherwise retained in the closed position. In certain examples, one of the barrier member 260 and the arcuate member 270 can include a locking mechanism 262 (e.g., a pin or latch) configured to be selectively movable between a locked position in which the locking mechanism is engaged with a complementary engagement feature 272 of the other of the barrier member 260 and the arcuate member 270 (e.g., an aperture or catch thereof) to retain the barrier member in the closed position (refer to FIG. 9 and FIG. 10) and an unlocked position in which the locking mechanism 262 is disengaged from the complementary engagement feature 272 to permit the barrier member 260 to be rotated away from the arcuate member 270 into the open position (refer to FIG. 11).

The cage 200c can be of any suitable size, shape, and/or material as desired to suit a particular application. By way of non-limiting example, the vertical members 220 of the cage 200c can have a length of about 30 inches, such that the barrier member 260 and the arcuate member 270 are elevated about 30 inches above the platform 100. By way of further non-limiting example, the lateral member(s) 210, the vertical member(s) 220, the barrier member 260, and/or the arcuate member 270 of the cage 200c can be tubular in shape. By way of further non-limiting example, the cage 200c can be formed from a marine-grade and/or corrosion-resistant material, such as a metal or carbon fiber.

With specific reference to FIG. 12, the cage 200c can be removably coupled to the platform 100. In this regard, a fisherman can selectively couple and decouple the cage 200c from the platform 100, as desired, which allows the fisherman to modularly use the casting platform system 10 as desired to suit a particular application. According to one example, a pair of attachment mechanisms 130 can be attached to the lower face 114 of the base plate 110 of the platform 100. One of a pair of lateral members 210 can then be removably coupled to a corresponding first one of the attachment mechanisms 130, and the other of the pair of lateral members 210 can then be removably coupled to a corresponding second one of the attachment mechanisms 130, in the same way as previously described with respect to the seat 200a. Additionally, as will be appreciated with additional reference to FIGS. 9-11, each vertical member of the second pair of vertical members 220b can be operatively connected to the platform 100. In examples, each vertical member of the second pair of vertical members 220b can include a second engagement feature 226. The engagement features 226 of the vertical members of the second pair of vertical members 220b can be shaped complementary to first engagement features (e.g., slots 110a) defined by the base plate 110 of the platform 100 so as to enable each second engagement feature 226 to be removably coupled with a corresponding one of the first engagement features, such as is illustrated in FIG. 9 and FIG. 12. In certain examples, each second engagement feature 226 can be configured to be at least partially slidably received with a corresponding one of the first engagement features such that the cage 200c is configured to be removably coupled to the platform 100 via sliding engagement between each of the second engagement features 226 and a corresponding one of the pair of first engagement features. In particular examples, each first engagement feature of the pair of first engagement features can be a slot 110a defined in the base plate 110 and extending therethrough from the upper face 112 to the lower face 114, as described herein, and each of the second engagement features 226 can be in the form of or include a protrusion 226a extending outwardly away from a proximal end of the corresponding vertical member of the second pair of vertical members 220b. In such examples, the protrusions 226a can be configured to at least partially pass through and engage with a corresponding one of the slots 110a defined in the base plate 110. For example, the cage 200c can be removably coupled to the platform 100 by positioning the protrusion 226a of each vertical member of the second pair of vertical members 220b adjacent a corresponding slot 110a of the base plate 110 and then sliding the protrusion 226a of each vertical member of the second pair of vertical members 220b laterally (e.g., in a direction toward the forward end 140a of the frame 140), such that each slot defined through the base plate 110 of the platform 100 slidingly receives a corresponding protrusion 226a of a vertical member of the second pair of vertical members 220b. Although the example illustrated in FIGS. 9-12 relies on the foregoing methods of attachment, other examples for removably coupling the cage 200c to the platform 100 are not so limited, and it is to be understood that the attachment means described with respect to FIGS. 9-12 could be applied to any modular support accessory.

FIGS. 13A-13C more particularly illustrate a means for attaching the lateral member(s) 210 of the modular stability accessory 200 to the attachment mechanism(s) 130 of the platform 100. The attachment method illustrated in FIGS. 13A-13C and described herein can, in examples, be equally applicable to any modular stability accessory 200, particularly including the seat 200a, the sissy bar 200b, and the cage 200c described herein. As illustrated, a lateral member 210 of the modular stability accessory 200, namely the first end 214a of the rod member 214 thereof, is aligned with the receiving opening 132 of the attachment mechanism and then slid into the attachment mechanism 130 in the direction of the arrow A in FIG. 13A. As the lateral member 210 is slid into the attachment mechanism 130, the rod member 214 slides over the plunger 136 of the attachment mechanism 130, thereby driving the plunger 136 into an opening in the sidewall. The lateral member 210 is slid into the attachment mechanism 130 until the lateral member 210 locks into place when the groove 207 defined by the rod member 214 aligns with the plunger 136, thereby causing the plunger to extend back through the opening in the sidewall of the attachment mechanism 130 and engage with the rod member 214 by being at least partially seated within the groove 207 (refer to FIG. 13B). As a result, the lateral member(s) 210 are secured within the attachment mechanism(s) 130, thereby attaching or coupling the modular stability accessory 200 to the platform 100. As shown in FIG. 13C, the plunger 136 can have base portion secured (e.g., welded) to the attachment mechanism. Referring again to FIG. 2A, to detach or decouple the modular stability accessory 200 from the platform 100, the a user need only displace a wire 134 extending between and interconnecting the plungers 136 (e.g., by pulling the wire 134 downward), thereby causing the plungers 136 to move toward one another and out of engagement with the grooves 207 of the corresponding lateral members 210, which allows the lateral members 210 to once again be slid out of the attachment mechanisms 130 (e.g., in a direction opposite the arrow A in FIG. 13A).

As will be appreciated, a chosen modular stability accessory 200 (e.g., a seat 200a, a sissy bar 200b, a cage 200c) can be selectively swapped out for another quickly and effectively as desired to suit a particular application. Providing a quick and convenient means for swapping out one modular stability accessory 200 for another without having to remove or replace the platform advantageously enables use of the casting platform system 10 in a wide variety of applications and by a wide variety of users of different sizes and/or with different preferences. For example, seat 200a can be preferred in calm waters or when the boat is stationary, the sissy bar 200b can be preferred in relatively rougher waters, when the boat is moving at low speeds, or when the fisherman only needs to stand for a short period of time, and the cage 200c can be preferred in the roughest waters, when the boat is moving at high speeds, or when the fisherman needs to stand for an extended period of time. As will be appreciated, the modularity of the casting platform system 10 is thus advantageous for many applications, especially using the modular stability accessories 200 described herein, each of which is selectively attachable to the same platform 100 described herein. The modularity of the casting platform system 10 and the interchangeability of the modular stability accessories 200 advantageously allows for the purchase of a single platform 100 and any desirable number of modular stability accessories 200 that can each be used with the platform 100.

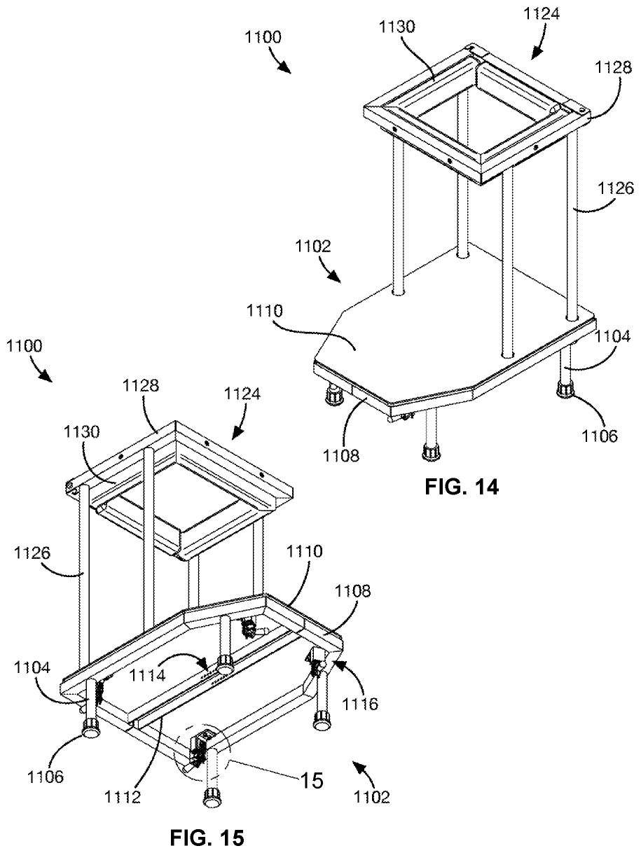

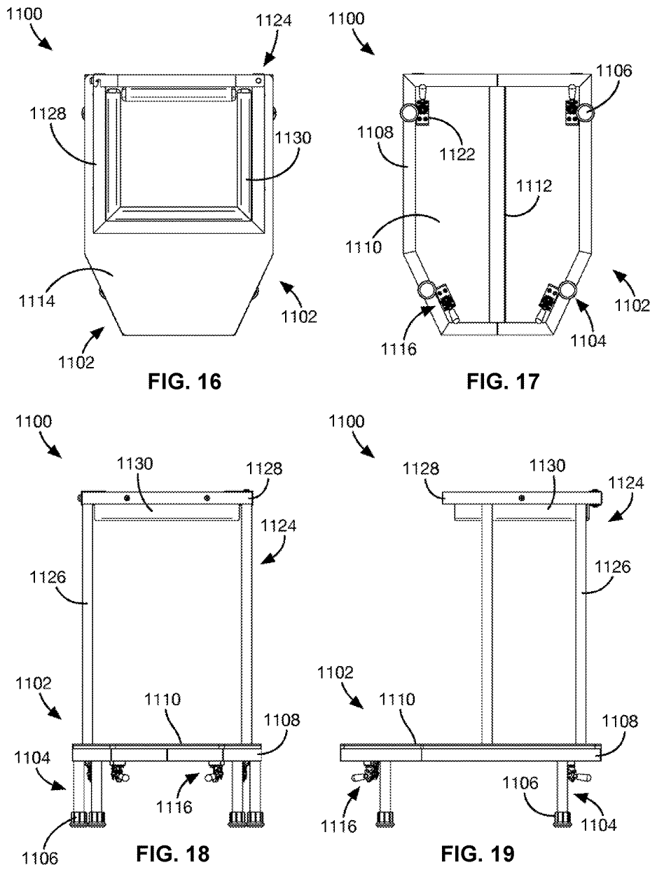

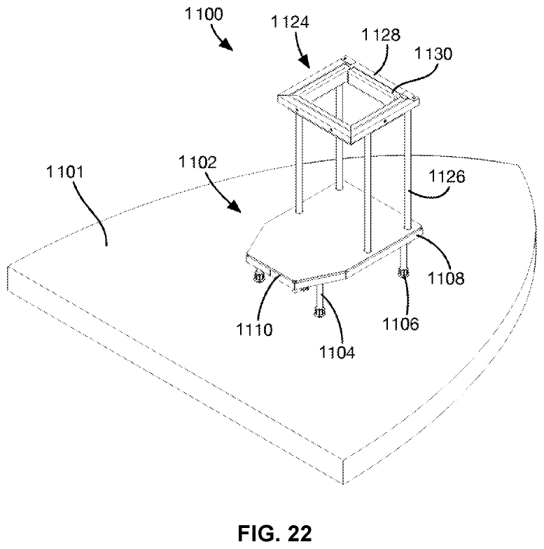

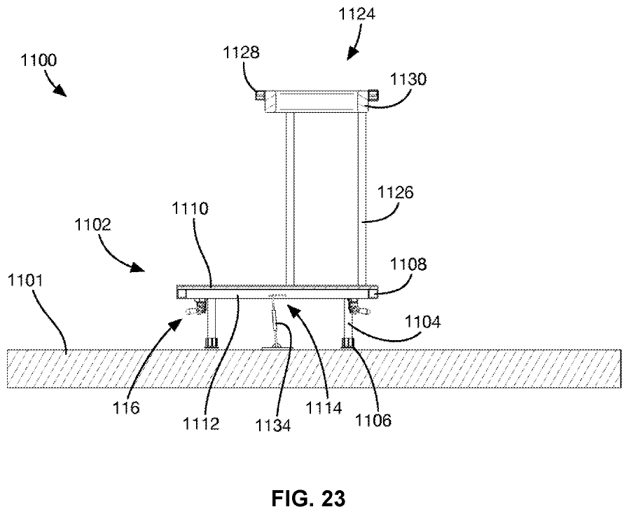

Referring now to FIGS. 14-23, an exemplary modular casting platform system 1100 is shown. The modular casting platform system includes a casting platform 1102 that is supported on a boat deck 1101 (FIGS. 22-23) by a support frame 1108. The support frame 1108 is supported by a plurality of support legs or posts 1104. The support legs 1104 can include optional feet 1106 for embodiments of the casting platform 1102 that sit on top of the boat deck 1101 (as opposed to casting platforms 1102 that can be removably fastened to the boat deck with fasteners). The support legs 1104 support the support frame 1108 at a height above the boat deck 1101 that is determined by the length of the support legs 1104. The support legs 1104 are cut to the desired height of the platform 1102 during manufacturing.

Alternatively, the support legs 1104 can have an adjustable height via a telescoping mechanism or by being interchangeable with legs or posts having a different height. The illustrated embodiment does not include adjustable members, e.g., the support legs 1104, to avoid the noise generated by mechanisms used to connect or join together the moveable members used to adjust, for example, the height of the support legs. Suitable locking mechanisms for enabling the adjustability of the casting platform or support accessory can include, for example, rubberized locking components, such as cams or clamps that facilitate locking the relative positions of the components without parts that could generate noise, such as cotter pins, or the like.

The support legs 1104 are attached to the support frame 1108 can be arranged around a perimeter of the casting platform 1102. The support frame 1108 can be formed from any suitable rigid and strong material and supports a base plate 1110 of the casting platform 1102. For example, the support frame 1108 can be formed from welded together segments of metal tubing having a square, rectangular, round, or other suitable cross-sectional profile, the tubing being formed from any suitable metal alloy, such as alloys of aluminum, steel, and the like. An optional center beam 1112 can extend between two sides of the support frame 1108 to provide additional support, stiffness, and rigidity to the base plate 1110 of the casting platform 1102. The center beam 1112 can optionally include an attachment location 1114 including one or more holes or other features for receiving a securing member 1134 (FIG. 23) that attaches the center beam 1112 of the casting platform 1102 to the deck 1101 of the boat. The attachment or securing member can take on a wide variety of forms, such as, for example, a turnbuckle, a rod with hooked ends, a tie down strap or line, or the like.

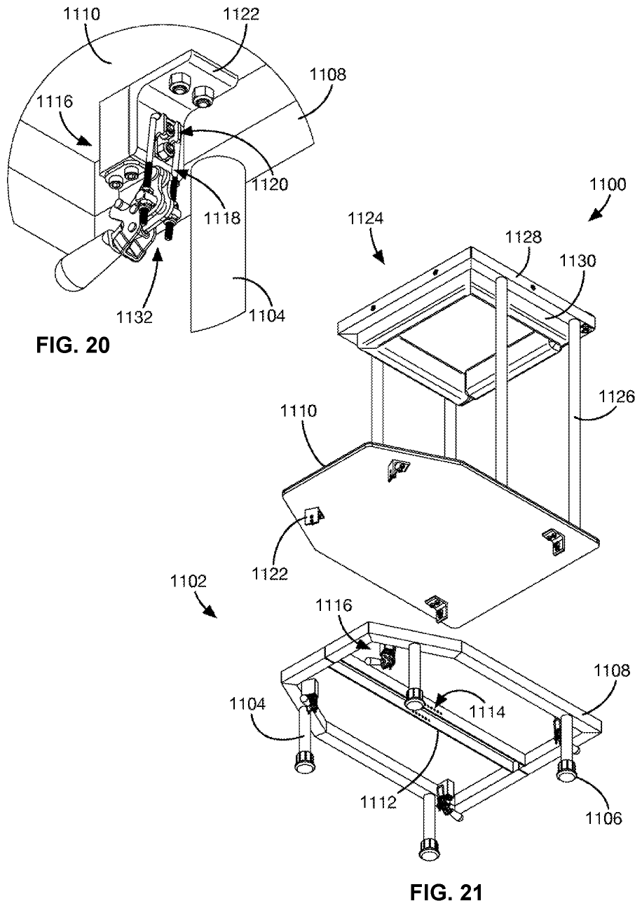

The base plate 1110 of the casting platform 1102 provides a flat elevated surface on which a fisherman can stand while fishing. The illustrated base plate 1110 is formed from a metal plate and does not include any holes for fasteners or the like. The base plate 1110 is secured to the support frame 1108 of the casting platform 1102 by a plurality of clamps 1116 attached to the support frame 1108. The examples of clamps 1116 shown in FIGS. 14-23 include a latch member 1118 that engages a catch member 1120 that is attached to the bottom surface of the base plate 1110 with a bracket 1122, such as, for example, an angle bracket as is shown in FIG. 20. The clamps 1116 can take on a wide variety of forms, such as, for example, retaining slots for receiving a tab or a pin, threaded fasteners, quarter-turn fasteners, hook or slide locking mechanisms, or any combination thereof.

When closed, the clamps 1116 provide sufficient clamping force to secure the base plate 1110 of the casting platform 1102 to the support frame 1108. The clamping force applied by the clamps 1116 can be adjusted by adjusting the relative positions of the latch member 1118 and the catch member 1120. In one implementation, the latch member 1118 position can be adjusted via one or more adjustment members 1132 that can be, for example, one or more threaded fasteners and an optional locking fastener. The clamping force of two or more clamps 1116 can be sufficient to safely retain the base plate 1110 of the casting platform 1102, thereby providing a stable platform even if one or more of the clamps 1116 fail or are inadvertently left open.

The base plate 1110 of the casting platform 102 can include a wide variety of features for improving the stability, longevity, and comfort of the fisherman who is fishing from the casting platform 1102. For example, the base plate 1110 can include a rubberized or otherwise high-friction top surface for added grip. The base plate 1110 can also include a support accessory 1124 supported by one or more support posts 1126 that extend vertically from the base plate 1110. The support accessory 1124 take on a wide variety of forms, such as, for example, a seat (not shown), a leaning rail (not shown), a wrap-around support cage 1128 shown in FIGS. 14-22, or the like. The support cage 1128 can also include optional cushions 1130 to provide added comfort to the fisherman.

The clamps 1116 can be quickly opened to allow for easy and fast removal of the casting platform 1102 and the attached support accessory 1124. That is, a first casting platform 1102 with an attached seat can be removed and replaced with a second casting platform 1102 that has an attached support cage, and vice versa. The interchangeability or modularity of the casting platform system 1100 allows the owner to purchase one support frame 1108 and any number of casting platforms 1102 including a wide variety of support accessories 1124, or to purchase additional casting platforms 1102 with different support accessories 1124 after the initial purchase of the casting platform system 1100. The support accessories 1124 can also be provided at a variety of fixed heights, necessitating the purchase of multiple support accessories 1124 for fishermen of different heights.

Swapping out one casting platform 1102 for another enables the boat owner (typically a fishing guide) to adapt to accommodate fishermen of different heights by attaching different height support accessories 1124 depending on who is fishing. Rough weather forecasts can also be adapted to, for example, by attaching casting platform with the support cage 1128 when rougher seas are predicted. The support cage 1128 provides significant improvements to stability and comfort in rough seas or when standing and fishing for extended periods of time.

The many features and advantages of the disclosure are apparent from the detailed specification and it is intended to cover all such features and advantages of the disclosure, which fall within the true spirit and scope of the disclosure. Since numerous modifications and variations will readily occur to those skilled in the art, it is not desired to limit the disclosure to the exact construction and operation illustrated and described and, accordingly, all suitable modifications and equivalents that fall within the scope of the disclosure of this application are supported for claiming in this or related applications.

What is claimed is:

1. A casting platform system for mounting on a boat deck, the casting platform system comprising:
a platform comprising:
a base plate defining an upper face and an opposite lower face;
at least one leg extending outwardly from the lower face of the base plate for supporting the base plate above the boat deck such that the lower face of the base plate faces an upper surface of the boat deck; and
at least one attachment mechanism attached to the lower face of the base plate;
and
a modular stability accessory comprising:
at least one lateral member configured to be removably coupled to the at least one attachment mechanism of the platform; and
at least one vertical member extending upwardly away from the at least one lateral member above the platform.

2. The casting platform system of claim 1, wherein the at least one attachment mechanism comprises a plurality of attachment mechanisms spaced apart from one another about the lower face of the base plate.

3. The casting platform system of claim 2, wherein the modular stability accessory is a seat, the seat comprising:
a pair of lateral members spaced apart from one another, each lateral member of the pair of lateral members configured to be removably coupled to a corresponding one of the plurality of attachment mechanisms;
a pair of vertical members spaced apart from one another, each vertical member of the pair of vertical members extending upwardly away from a corresponding lateral member of the pair of lateral members; and
a seat member attached to each vertical member of the pair of vertical members.

4. The casting platform system of claim 3, wherein the seat member comprises a seating surface and wings extending downwardly from the seating surface on opposing sides of the seating surface to form an inverted U-shape.

5. The casting platform system of claim 3, further comprising a cross bar extending between and interconnecting the pair of lateral members.

6. The casting platform system of claim 3, wherein the pair of vertical members are collectively formed from a single continuous tube.

7. The casting platform system of claim 2, wherein the modular stability accessory is a sissy bar, the sissy bar comprising:
a pair of lateral members spaced apart from one another, each lateral member of the pair of lateral members configured to be removably coupled to a corresponding one of the plurality of attachment mechanisms;
a pair of vertical members spaced apart from one another, each vertical member of the pair of vertical members extending upwardly away from a corresponding lateral member of the pair of lateral members; and
a handle attached to each vertical member of the pair of vertical members.

8. The casting platform system of claim 7, wherein the handle extends outwardly from each vertical member of the pair of vertical members, the handle terminating in grips at opposing ends thereof.

9. The casting platform system of claim 7, further comprising least one cross beam extending between and interconnecting the pair of vertical members.

10. The casting platform system of claim 7, further comprising a cross bar extending between and interconnecting the pair of lateral members.

11. The casting platform system of claim 2, wherein the modular stability accessory is a cage, the cage comprising:
a pair of lateral members spaced apart from one another, each lateral member of the pair of lateral members configured to be removably coupled to a corresponding one of the plurality of attachment mechanisms;
a first pair of vertical members spaced apart from one another, each vertical member of the first pair of vertical members extending upwardly away from a corresponding lateral member of the pair of lateral members;
a second pair of vertical members spaced apart from one another and from each vertical member of the first pair of vertical members, each vertical member of the second pair of vertical members extending upwardly away from, and configured to be removably coupled to, the platform;
an arcuate member extending between and interconnecting each vertical member of the first pair of vertical members and each vertical member of the second pair of vertical members to form a U-shape; and
a barrier member rotatably connected to the arcuate member and configured to be selectively rotatable relative to the arcuate member between a closed position and an open position.

12. The casting platform system of claim 11, further comprising a locking mechanism configured to be selectively movable between a locked position in which the locking mechanism is configured to retain the barrier member in the closed position and an unlocked position in which the locking mechanism is configured to permit the barrier member to be rotated away from the arcuate member into the open position.

13. The casting platform system of claim 11, wherein:
the base plate further defines a pair of first engagement features, and
each vertical member of the second pair of vertical members includes a second engagement feature shaped complementary to a corresponding one of the pair of first engagement features and is configured to be removably coupled therewith.

14. The casting platform system of claim 13, wherein each of the second engagement features is configured to be at least partially slidably received within a corresponding one of the pair of first engagement features, such that the cage is configured to be removably coupled to the platform via sliding engagement between each of the second engagement features and a corresponding one of the pair of first engagement features.

15. The casting platform system of claim 14, wherein:
each first engagement feature of the pair of first engagement features is a slot defined in the base plate and extending therethrough from the upper face to the lower face, and
each of the second engagement features is a protrusion extending outwardly away from a proximal end of the corresponding vertical member of the second pair of vertical members and configured to at least partially pass through and engage with a corresponding one of the slots defined in the base plate.

16. The casting platform system of claim 2, wherein the at least one lateral member comprises a pair of lateral members spaced apart from one another, each lateral member of the pair of lateral members defining a groove and configured to be removably coupled to a corresponding one of the plurality of attachment mechanisms, the casting platform system further comprising:
a plurality of locking mechanisms and a wire extending between and interconnecting the plurality of locking mechanisms, wherein each locking mechanism of the plurality of locking mechanisms is received through a sidewall of a corresponding one of the plurality of attachment mechanisms and is configured engage with the groove of a corresponding one of the pair of lateral members and to be moved out of engagement with the groove of the corresponding one of the pair of lateral members by displacing the wire.

17. The casting platform system of claim 1, wherein the at least one attachment mechanism defines a receiving opening and the at least one lateral member is configured to be at least partially slidingly received into the receiving opening.

18. The casting platform system of claim 1, wherein the at least one lateral member comprises a sleeve member and a rod member defining a first end configured to be disposed within the sleeve member and fixedly attached to the at least one vertical member and an opposite second end configured to be slidably disposed within the at least one attachment mechanism.

19. A boat, comprising:
a deck; and
the casting platform system of claim 1.

20. A casting platform system for mounting on a boat deck, the casting platform system comprising:
a platform including:
a base plate defining an upper face and an opposite lower face;
a plurality of legs spaced apart from one another, each leg of the plurality of legs extending outwardly from the lower face of the base plate for supporting the base plate above the boat deck such that the lower face of the base plate faces an upper surface of the boat deck; and
a pair of tubular attachment mechanisms, each attachment mechanism of the pair of attachment mechanisms being attached to the lower face of the base plate and defining a receiving opening; and
a modular stability accessory including:
a pair of tubular lateral members, each lateral member of the pair of lateral members defining a groove and configured to be at least partially slidingly receiving into the receiving opening of a corresponding attachment mechanism of the pair of attachment mechanisms of the platform;
a cross bar extending between and interconnecting the pair of lateral members;
a plurality of locking mechanisms and a wire extending between and interconnecting the plurality of locking mechanisms, wherein each locking mechanism of the plurality of locking mechanisms is received through a sidewall of a corresponding one of the pair of attachment mechanisms and is configured to engage with the groove of a corresponding one of the pair of lateral members and to be moved out of engagement with the groove of the corresponding one of the pair of lateral members by displacing the wire;
a pair of vertical members, each vertical member of the pair of vertical members extending upwardly away from a corresponding lateral member of the pair of lateral members above the platform; and
a stability member attached to each vertical member of the pair of vertical members, the stability member selected from the group consisting of a seat, a sissy bar, and a cage.
